(19) United States
(12) Patent Application Publication
(10) Pub. No.: US 2013/0024282 A1
(43) Pub. Date: Jan. 24, 2013

(54) AUTOMATIC PURCHASE HISTORY TRACKING

(71) Applicants: Aman Kansal, Redmond, WA (US); Jie Liu, Medina, WA (US); Douglas Christopher Burger, Redmond, WA (US)

(72) Inventors: Aman Kansal, Redmond, WA (US); Jie Liu, Medina, WA (US); Douglas Christopher Burger, Redmond, WA (US)

(73) Assignee: Microsoft Corporation, Redmond, WA (US)

(21) Appl. No.: 13/189,498

(22) Filed: Jul. 23, 2011

(51) Int. Cl. G06F 17/30; G06Q 30/00

(52) U.S. Cl. 705/14.53; 707/755; 707/E17.044

(57) ABSTRACT

The automatic purchase history tracking technique described herein can capture information about all of a user's purchases in a single location, such as, for example, a purchase database. In one embodiment when a user purchases an item from a vendor or store, a confirmation of the item purchase is received by the user. For example, this confirmation could be an email confirmation, a paper receipt or a voice confirmation. This confirmation is automatically parsed by the technique to extract purchase information about the item purchase. This parsed information can then be stored and displayed to the user and can also used for various other purposes, such as, for example, targeted marketing. The parsed stored data can also be enhanced by user annotations, and data pushed and pulled from other sources.

### BACKGROUND

Users make purchases at multiple vendors and use multiple payment mechanisms such as different credit cards. While purchases from a single vendor are currently stored by many vendors (e.g., associated with online user logins or loyalty cards) and purchases made using a single payment mechanism may be stored by the provider of that payment mechanism (e.g., a certain credit card provider may store purchase history), there is no easy mechanism to store all purchases across all vendors and payment mechanisms. To track their purchase history a user must typically collect receipts or manually record every purchase.

Additionally, large online vendors with millions of customers often have sufficient data about user purchases to make useful recommendations or provide other services based on user purchase behavior. However, small businesses and specialty product vendors are at a disadvantage because they can only record a small number of purchases

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The automatic purchase history tracking technique described herein enables the capture of information about all of a user's purchases. In one embodiment of the technique when a user purchases an item form a vendor, a confirmation of the purchase is received by the user. For example, this confirmation could be an email confirmation, a paper receipt or a voice confirmation. This confirmation is automatically parsed by the technique to extract purchase information about the item purchase. This parsed information can then be stored in a single location (e.g., in a purchase database) and displayed to the user, and can also used for various other purposes. The stored information about a user's various purchases over time can be termed as the user's purchase history.

In one embodiment, the technique provides for the enhancement of purchase records. For example, after the purchase information has been captured, the technique can use it to fetch additional information related to that product from other sources (e.g., over a network). This information can be added to the product purchase record for easy access by the user. The technique also allows users to enter certain annotations to purchase records either at the time of entering the purchase transaction information (such as, for example, when scanning a paper receipt) or afterwards when viewing the purchase record.

The technique also accepts purchase information uploaded by vendors such as, for example, from their point of sales devices. The technique can also be used to gather purchase history information about multiple users and this information may be used for various purposes, such as targeting sponsored information based on user's purchase behavior.

Additionally, in some embodiments, the technique makes provisions to protect a user's privacy. For example, the technique allows various user-specified rules to be entered to preclude various transactions from being entered into the purchase database. These rules may also be learned by the system based on which purchases the user typically deletes from their purchase history.

### DESCRIPTION OF THE DRAWINGS

The specific features, aspects, and advantages of the disclosure will become better understood with regard to the following description, appended claims, and accompanying drawings where:

FIG. 1 depicts a flow diagram of an exemplary process for practicing one embodiment of the automatic purchase history tracking technique described herein.

FIG. 2 depicts another flow diagram of another exemplary process for practicing the automatic purchase history tracking technique described herein.

FIG. 3 is an exemplary architecture for practicing one exemplary embodiment of the automatic purchase history tracking technique described herein.

FIG. 4 is a schematic of an exemplary computing environment which can be used to practice the automatic purchase history tracking technique.

### DETAILED DESCRIPTION

In the following description of the automatic purchase history tracking technique, reference is made to the accompanying drawings, which form a part thereof, and which show by way of illustration examples by which the automatic purchase history tracking technique described herein may be practiced. It is to be understood that other embodiments may be utilized and structural changes may be made without departing from the scope of the claimed subject matter.

1.0 Automatic Purchase History Tracking Technique

The following sections provide an overview of the automatic purchase history tracking technique, details of various aspects of the technique, as well as exemplary processes and an exemplary architecture for practicing the technique.

1.1 Overview of the Technique

The automatic purchase history tracking technique described herein can provide for the capture of information about all of a user's purchases in a single location, for example, a purchase database. In one embodiment when a user purchases an item from a vendor, a confirmation of the item purchase is received by the user. This confirmation is automatically identified and parsed by the technique to extract purchase information about the item purchase. This parsed purchase information can then be stored and displayed to the user and can also be used for various other purposes.

The technique also provides for the enhancement of purchase records through user annotations and by allowing the additional information about an item or service to be downloaded from other sources. For example, after the purchase information has been captured, the technique can use it to fetch additional information related to that product (e.g., via a network) and add it to the product purchase record. Additionally, in some embodiments, the technique also accepts purchase information uploaded (e.g., pushed) by vendors to enhance the purchase records.

The technique can also be used to gather purchase history information about multiple users and this information may be used for various purposes, such as targeting sponsored information based on user's purchase behavior. Privacy protections for the user's purchase history are provided by the technique to preclude a user's sensitive data from being disclosed to other parties.

These various capabilities, and others, are described in greater detail in the paragraphs below.

1.2 Capture Mechanisms

The technique can provide for various mechanisms to capture purchase information in various forms, including email confirmations, paper receipts, voice input and any type of text input.

1.2.1 Email Confirmation Identification, Capture and Parsing

Typically, for online purchases and certain other purchases (such as travel purchases, phone orders, etc), a vendor will send an email confirmation. In one embodiment, the technique accesses a user's email account using user provided credentials and identifies and selects emails that appear to be purchase confirmations. For example, the technique may identify an email as a purchase confirmation based on the presence of certain words in the email such as “purchase”, “order”, “shipped”, and so forth. However, other natural language processing methods may be applied to identify purchase confirmations as will be known to those skilled in the art. Natural language processing methods may include interpreting the semantic content of an email to infer if it is related to a purchase.

In order to identify and extract email confirmations of one or more purchase, in some embodiments, the technique may automatically check for such emails (such as periodically) or do so based on user request. Alternatively, in one embodiment, the user may forward the purchase conformation emails for the purchases the user wishes to track to a designated email address that is accessible by the technique.

Once one or more purchase confirmations have been identified and obtained, the purchase confirmations are parsed to extract information about the item and the purchase. For example, in one embodiment, the technique parses the confirmation emails to extract purchase information such as, for example, purchased product name; purchase price; shipping or tracking information (if any); return policy information (provided within the email confirmation or obtained from the vendor's website); sales tax paid; and discount or rewards points earned for future purchases. This information is then stored in a purchase database that is either on the user's computing device, or on a server or computing cloud and is accessible to the user over a network connection between the user's computing device and the server/computing cloud.

1.2.2 Paper Receipt Capture

Certain purchases do not result in an electronic conformation but only a paper receipt for the user. In this case, in one embodiment, the technique provides a mechanism to capture a paper receipt with a camera. For example, a camera may be built into a user's mobile phone and the receipt capture functionality may be executed on the phone itself. A video of the receipt is captured and multiple frames are processed using known methods to obtain an enhanced image of the receipt. This image is parsed using known optical character recognition methods to extract the text content of the receipt. This text content is then parsed to extract similar information as discussed above with respect to parsing email confirmations. The parsed information is also stored in the purchase database as discussed above.

1.2.3 Voice Input

In some embodiments, the automatic purchase history tracking technique also provides the capability to capture voice input regarding purchases and converts this purchase information into a format compatible with the purchase database. For example, certain purchases may not result in either electronic or paper receipts (e.g., tips paid for luggage assistance) or the receipt may have been lost. In such cases, the technique allows entering the purchase information using a multitude of user interface technologies such as voice input, text typed on a keyboard, or pointing a camera at the product purchased. For example, when a camera is pointed at the purchased product, the product can be identified using image recognition methods. Alternatively the camera may be pointed at the bar code label on the product and the camera image can be processed to identify the bar code, which reveals the product code and an online service can he used to lookup additional product information such as price. In this case parsing is not required. This information, once converted to text, is then automatically parsed as discussed previously and entered into the purchase database.

1.3 Enhancing Purchase Records

As discussed previously, the automatic purchase history tracking technique provides various methods to enhance purchase records in the purchase database. These include the extraction of additional information from other sources, user-entered annotations and vendor-assisted information capture.

1.3.1 Extraction of Additional Information from other Sources.

After the purchase information has been captured, the technique, in one embodiment, uses it to fetch additional information related to that product, For instance, it may search the Internet to extract information about product accessories that will be useful for enhancing the product (e.g., connector cables, protection plans). Other information that can be extracted can include reviews or usage tips by other consumers, product related advisories issued by consumer protection agencies, or relevant information from competing manufacturers, user manuals for that product and a list of related products that are found helpful by other users who purchased the recorded product. Other information that can be extracted includes product warranties, vendor return polices, and the like. This information is added to the product purchase record for easy access by the user. In one embodiment, the information can be searched using available online search engine services that can fetch related links given keywords such as the product name. In other embodiments, the information could be provided by sponsors who have listed the products for which their information should be added. For instance, a manufacturer of HDMI cables may provide information to be added to all purchases of television and video equipment.

1.3.2 User-Entered Annotations.

In some embodiments, the technique also allows users to enter certain annotations to purchase records either at the time of entering the transaction information (such as when scanning a paper receipt) or afterwards when viewing the purchase record. Such annotations may include, for example, information such as who the purchase is for, whether it is a business expense, whether the purchase is tax deductable, and so on.

1.3.3 Vendor-Assisted Purchase Information Capture.

In addition to the automated mechanisms described above the technique in some embodiments also accepts purchase information uploaded by vendors. In one embodiment, the automatic purchase history tracking technique parses the information uploaded by a vendor or other party to extract information that identifies the user (such as credit card number, loyalty card number, or sales clerk added user name) and adds the purchase information to the list of purchases made by that user in the purchase database.

1.4 Use of Purchase Histories

In some embodiments, the automatic purchase history tracking technique described herein can be used to gather purchase history information about multiple users and this information may be used for various purposes, such as targeting sponsored information based on a user's purchase behavior. Current systems used by vendors for recommendations typically rely only on the purchases made by a user (or similar users) at that vendor. In some embodiments of the automated purchase history tracking technique, purchases across multiple vendors are captured and stored in a combined purchase history database for multiple users. Such a combined purchase history database might have, for example, for each user, purchased product name, purchase price, shipping or tracking information (if any), return policy information, sales tax paid, and discount or rewards points earned for future purchases. This also helps level the playing field for smaller vendors, such as those specializing in certain product categories, who would otherwise not have access to large sets of purchase histories. Of course, many other types of information may equally well be stored. The combined purchases are then used to better infer user profile using any conventional user profiling technique.

The automatic purchase tracking technique can also allow vendors to use user-added annotations in providing targeted markets. For instance, the user annotations can allow a vender to know if a purchase made by the user is for the user or their spouse. In this case the vendor may use this information to send recommendations to a user about products that are of interest only to the user instead of the user's spouse. The use of user annotations allows better inference of user interests, because user entered annotations typically provide information not present in the purchase transaction.

1.5 Privacy.

Some embodiments of the automatic purchase tracking technique provide mechanisms to protect a user's privacy. For example, in some embodiments of the automatic purchase history tracking technique, the technique allows various user-specified rules to be entered into the purchase database system. For instance, the user may specify that certain purchases from certain stores and certain types of products are to be automatically dropped from the record (e.g., prescription medications, tobacco, gifts for lovers other than the user's spouse). These rules may be based on information contained within the purchase transaction (name of the store, product, location of the purchase) or be based on an annotation added by the user using a voice memo or some other user interface. These rules may also be learned by the system based on which purchases the user typically deletes from their purchase history. Alternatively, these rules could be based on legal requirements (such as HIPAA) that prohibit certain information from being tracked. Additionally, the rules could also include specificaions from privacy experts or social scientists who have determined that it is in the best interest of users or vendors that certain purchase behaviors not be recorded.

Various capabilities of the automatic purchase history tracking technique having been discussed, the following sections provide exemplary processes and an exemplary architecture for practicing the technique.

2.0 Exemplary Processes for Practicing the Technique

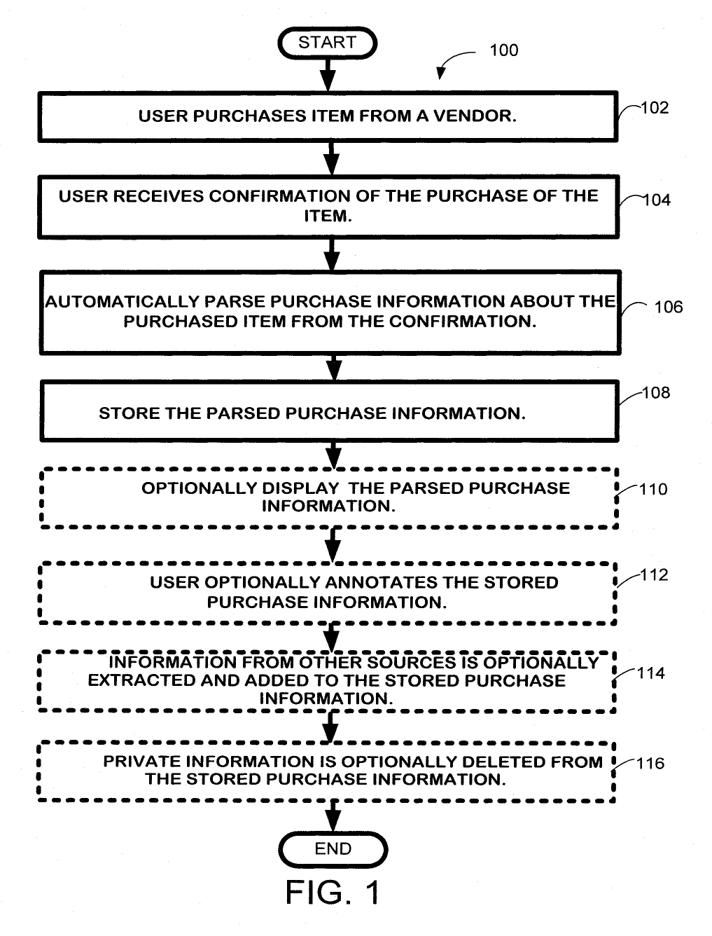

FIG. 1 provides an exemplary process for practicing one embodiment of the automatic purchase history tracking technique. As shown if FIG. 1, block 102, a user purchases an item from a vendor. A confirmation of the purchase of the item is received by the user, as shown in block 104. The confirmation can be in the form of an electronic mail regarding the purchase of the item. The confirmation can also be in the form of a paper receipt. In this case an image of the paper receipt can be captured and converted to text. Alternately, the confirmation can be an audio confirmation which is converted to text via a speech to text utility.

The purchase information about the purchased item is automatically parsed from the confirmation, as shown in block 106. This can be done by identifying specific words in the confirmation (e.g., words such as purchase, order, shipped) and extracting information in the confirmation related to these specific words and their location in the confirmation. The parsed information about the purchased item is stored, as shown in FIG. 108. For example, the parsed information can be stored in a purchase database on the user's computing device, on a server, or even on a computing cloud. The stored information about the purchased item can be displayed to the user, as shown in block 110. The user can then optionally manually annotate the stored information about the purchased item with additional information about the purchased item (block 112). Or the purchase information can be automatically annotated with information obtained from other sources such as from the manufacturer of the purchased item or from the vendor of the purchased item (block 114).

In one embodiment of the technique, a user can specify that information regarding certain types of purchases should not be stored and this information will be automatically deleted from the purchase (block 116). Or certain information may not be stored due to rules implemented by the technique that inhibit certain types of item purchases from being stored. These rules can be specified by the user, can be specified by the technique or can be learned by the technique based on a user's actions in managing (e.g., deleting) entries from the purchase database. In these cases, information regarding these purchases will be deleted from the purchase database or optionally will never be added to the purchase database, thereby protecting the user's privacy.

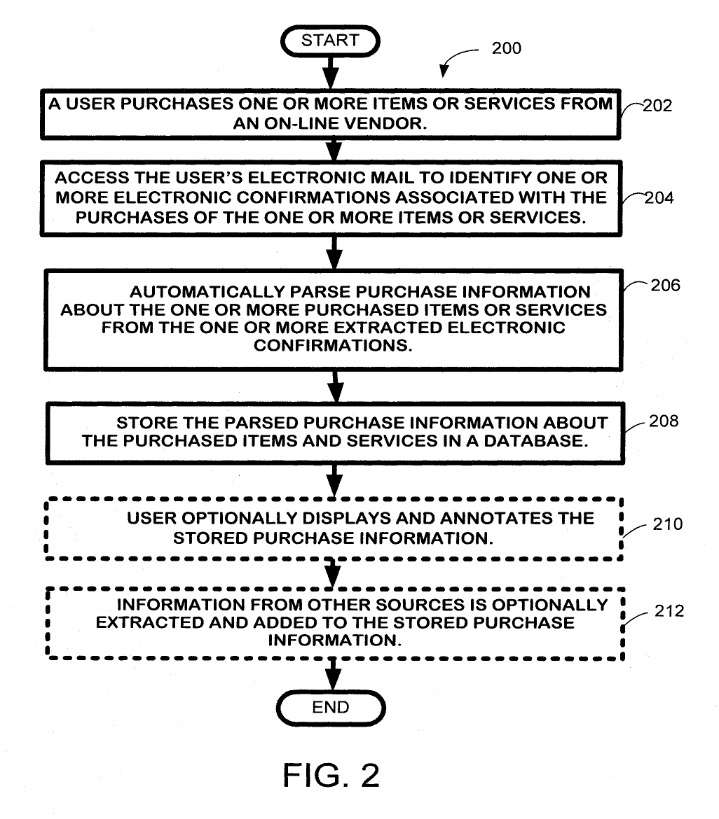

FIG. 2 provides another exemplary process for practicing another embodiment of the automatic purchase history tracking technique. In this embodiment, a user purchases one or more items or services from an on-line vendor. The user's electronic mail is accessed in order to identify one or more electronic confirmations associated with the purchases of the one or more items or services, as shown in block 204. This access of a user's electronic confirmations can take place in a variety of ways. For example, in one embodiment of the automatic purchase tracking technique, the user's electronic mail is automatically forwarded from an electronic mail server that stores the user's emails to a parsing engine (for example, on the user's computing device or on a server in a network or in a computing cloud) which parses the purchase information. In one embodiment of the technique, the user selectively forwards electronic mail for items and services the user wants to track to a parsing engine on a server which parses the purchase information from the confirmation. In another embodiment the user's electronic mail is periodically checked to identify one or more additional electronic confirmations.

The electronic confirmations in all of the above cases can be are identified by searching the electronic mail for words that are associated with the purchase of items and services as previously discussed.

Once the electronic confirmations are identified and obtained, the identified electronic confirmations are automatically parsed to extract the purchase information about the one or more purchased items or services from the one or more extracted electronic confirmations, as shown in block 206.

The parsed purchase information is then stored, as shown in block 208, and the stored parsed purchase information can optionally be displayed to the user (block 210). Like the embodiments discussed with respect to FIG. 1, the user can then optionally manually annotate the stored information about the purchased item with additional information (block 210). Or the purchase information can be automatically annotated with information obtained from other sources such as from the manufacturer of the purchased item or from the vendor of the purchased item (block 212) as previously discussed.

It should be noted that the parsed purchase information obtained via the exemplary process depicted in FIG. 2 can be combined with stored purchase information in the purchase database obtained from paper receipts and text and voice input.

3.0 Exemplary Architecture

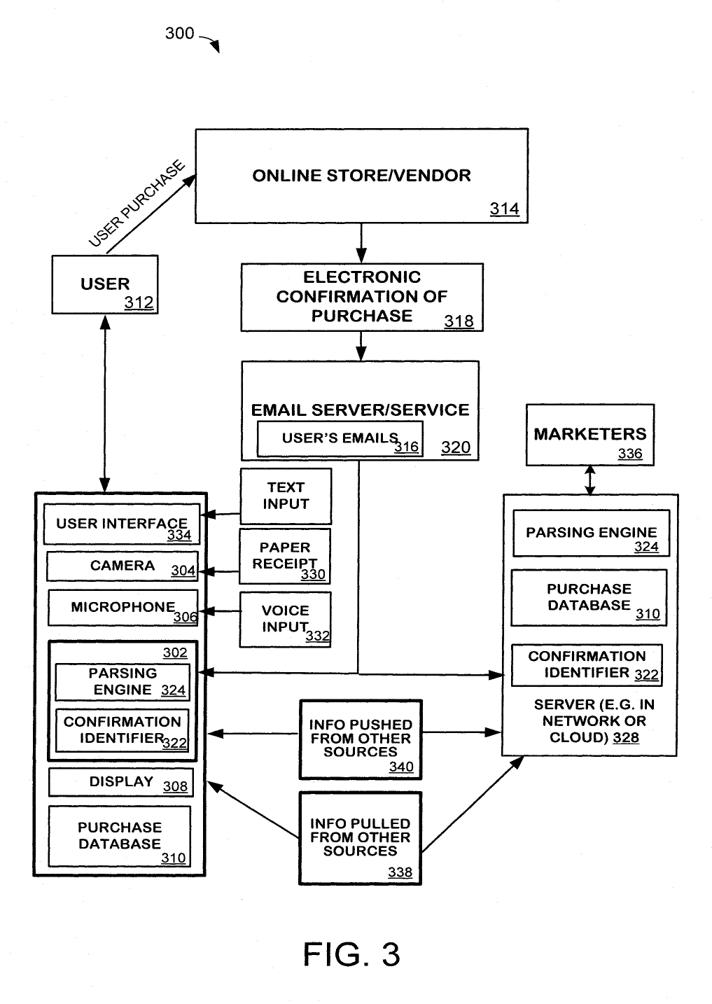

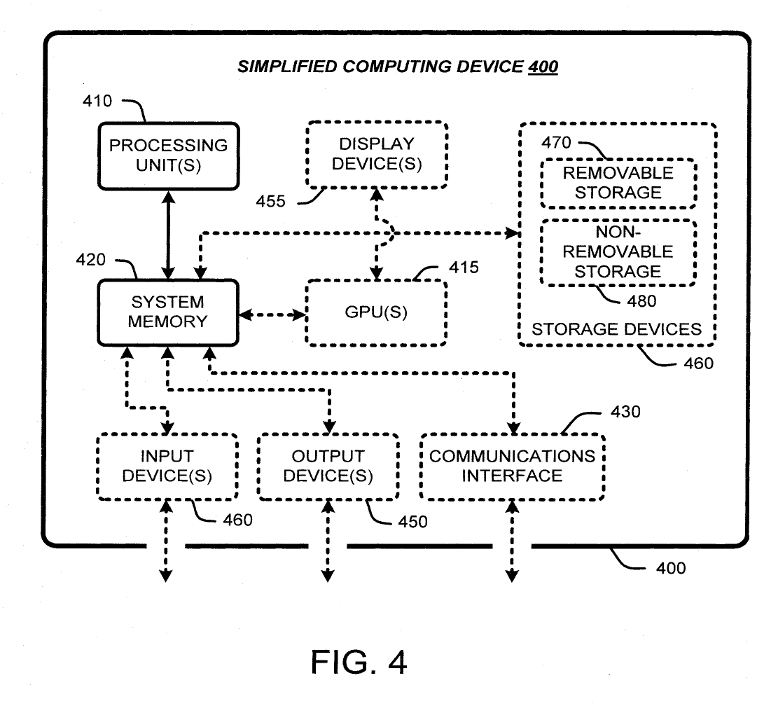

FIG. 3 shows an exemplary architecture 300 for practicing one embodiment of the automatic purchase history tracking technique. As shown in FIG. 3, an automatic purchase tracking module 302 is located on a computing device 400, which will be described in greater detail with respect to FIG. 4. The computing device 400 can include a camera 304 and a microphone 306, and a display 308, and can be used to store a purchase database 310 of items purchased.

When a user 312 purchases an item from a store or vendor, for instance an online store/vendor 314, the online store/vendor sends a purchase confirmation 318 to the user's email address and the user's emails 316 are stored on an email server/service 320. The automatic purchase tracking module 302 on the computing device 400 identifies the user's emails with purchase confirmations 318 via a confirmation identification module 322, on the user's computing device 400 or on a server 328 and downloads the purchase confirmations 318. A parsing engine 324 parses various fields from the downloaded confirmations 318 to create a purchase database 310 of the purchases. It should be noted that the confirmation identifier 322 and the parsing engine 324 can equally well reside on a server 328, for example, a backend server in a computing cloud, in which case these identification and parsing functions would be executed on the server. The purchase database 310 can also be located on the server 328, instead of the user's computing device, or the purchase database 310 can be stored both on the user's computing device 400 and the server 328.

The camera 304 and a microphone 306 can be used to convert paper receipts 330 and voice inputs 332 into a format compatible with the purchase database 310 (for example, in an alphanumeric format) as previously discussed. This conversion of images of the paper receipts or voice inputs can take place via conventional conversion techniques as will be known to those with ordinary skill in the art. User annotations can also be entered into the purchase database 310 by a user via a user interface 334 to the computing device 400.

As previously discussed, the purchase database 310 can be stored on the user's computing device 400 and/or it can reside on a server 328 and be accessible to the user via a network connection. If the purchase database 310 resides on a server 328, in either a network or a computing cloud, marketers 336 can use the information, if allowed by the user, to target the user for advertisements for other products and services based on the user's purchase history stored in the user's purchase database 310. The purchase databases of multiple users can also be used to analyze the purchasing habits of groups of users and use this analysis for marketing purposes as previously discussed.

Information pulled from other sources 338 or information pushed from other sources 340 (e.g., vendors) can also be added to the records in the purchase database 310.

4.0 Exemplary Operating Environments:

The automatic purchase history tracking technique described herein is operational within numerous types of general purpose or special purpose computing system environments or configurations. FIG. 4 illustrates a simplified example of a general-purpose computer system on which various embodiments and elements of the automatic purchase history tracking technique, as described herein, may be implemented. It should be noted that any boxes that are represented by broken or dashed lines in FIG. 4 represent alternate embodiments of the simplified computing device, and that any or all of these alternate embodiments, as described below, may be used in combination with other alternate embodiments that are described throughout this document.

For example, FIG. 4 shows a general system diagram showing a simplified computing device 400. Such computing devices can be typically found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the automatic purchase history tracking technique, the device should have a sufficient computational capability and system memory to enable basic computational operations. In particular, as illustrated by FIG. 4, the computational capability is generally illustrated by one or more processing unit(s) 410, and may also include one or more GPUs 415, either or both in communication with system memory 420. Note that that the processing unit(s) 410 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 4 may also include other components, such as, for example, a communications interface 430. The simplified computing device of FIG. 4 may also include one or more conventional computer input devices 440 (e.g., pointing devices, keyboards, audio input devices, video input devices, haptic input devices, devices for receiving wired or wireless data transmissions, etc.). The simplified computing device of FIG. 4 may also include other optional components, such as, for example, one or more conventional computer output devices 450 (e.g., display device(s) 455, audio output devices, video output devices, devices for transmitting wired or wireless data transmissions, etc.). Note that typical communications interfaces 430, input devices 440, output devices 450, and storage devices 460 for general-purpose computers are well known to those skilled in the art, and will not be described in detail herein.

The simplified computing device of FIG. 4 may also include a variety of computer readable media. Computer readable media can be any available media that can be accessed by computer 400 via storage devices 460 and includes both volatile and nonvolatile media that is either removable 470 and/or non-removable 480, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the automatic purchase history tracking technique described herein, or portions thereof, may be stored, received, transmitted, or read from any desired combination of computer or machine readable media or storage devices and communication media in the form of computer executable instructions or other data structures.

Finally, the automatic purchase history tracking technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for automatically tracking purchases, comprising:
receiving a confirmation of a purchase of an item;
automatically parsing purchase information about the purchased item from the confirmation;
storing the parsed information about the purchased item; and
displaying the stored information about the purchased item.

2. The computer-implemented process of claim 1, further comprising manually annotating the stored information about the purchased item with additional information about the purchased item from other sources.

3. The computer-implemented process of claim 1, wherein the confirmation is in the form of an electronic mail regarding the purchase of the item.

4. The computer-implemented process of claim 1, wherein the confirmation is in the form of a paper receipt and wherein an image or video of the paper receipt is captured and converted to text prior to parsing the purchase information.

5. The computer-implemented process of claim 1, wherein the confirmation is an audio confirmation and wherein the audio confirmation is converted to text via a speech to text utility prior to parsing the purchase information.

6. The computer-implemented process of claim 1, further comprising automatically annotating the stored information with information pushed from another source.

7. The computer-implemented process of claim 1, further comprising automatically annotating the stored information with information pulled from another source.

8. The computer-implemented process of claim 1, wherein a user can specify that information regarding certain types of purchases should not be stored.

9. The computer-implemented process of claim 1 further comprising learned rules that inhibit certain types of item purchases from being stored.

10. A system for automatically tracking purchases made by a user, comprising:
a general purpose computing device;
a computer program comprising program modules executable by the general purpose computing device, wherein the computing device is directed by the program modules of the computer program to,
obtain purchase transaction data for each item purchased by a given user;
automatically parse specific information from the purchase transaction data; and
store the parsed data in a database for later use.

11. The system of claim 10 wherein the purchase transaction data for the given user is obtained from electronic mail regarding the given user's purchases.

12. The system of claim 11 wherein the stored purchase data is stored on a server and wherein the parsed stored data is accessible to the user and to marketers.

13. The system of claim 12 wherein the marketers can use the stored data to target advertisements for the given user.

14. The system of claim 11 wherein the given user forwards the electronic mail to be parsed from the user's electronic mail box.

15. The system of claim 11 wherein the electronic mail is automatically accessed for parsing using the user's email user name and password.

16. A computer-implemented process for automatically tracking purchases, comprising:
accessing a user's electronic mail to identify one or more electronic confirmations associated with the purchases of the one or more items or services by the user;
extracting the identified one or more electronic confirmations;
automatically parsing purchase information about the one or more purchased items or services from the one or more extracted electronic confirmations;
storing the parsed purchase information about the purchased items and services for later use.

17. The computer-implemented process of claim 17 wherein identifying the one or more electronic confirmations further comprises searching the electronic mail for words that are associated with the purchase of items and services.

18. The computer-implemented process of claim 16 wherein a user's electronic mail is automatically forwarded from an electronic mail server to a parsing engine on a server which parses the purchase information.

19. The computer-implemented process of claim 16 wherein a user selectively forwards electronic mail for items and services the user wants to track to a parsing engine on a server which parses the purchase information.

20. The computer-implemented process of claim 16 further comprising using the parsed purchase information for marketing goods and services to the user.
